(19) United States
(12) Patent Application Publication
(10) Pub. No.: US 2015/0329367 A1
(43) Pub. Date: Nov. 19, 2015

(54) METHOD FOR PREPARING TRICHLOROSILANE

(71) Applicant: HANWHA CHEMICAL CORPORATION, Seoul (KR)

(72) Inventors: Gil Ho Kim, Daejeon (KR); Gui Ryong Ahn, Daejeon (KR); Won Ik Lee, Gyeonggi-do (KR); Joon Hwan Kim, Daejeon (KR); Kyung Hoon Cho, Daejeon (KR)

(73) Assignee: Hanwha Chemical Corporation, Seoul (KR)

(21) Appl. No.: 14/650,620

(22) PCT Filed: Feb. 26, 2014
(86) PCT No.: PCT/KR2014/001577

§ 371 Date: Jun. 9, 2015

(30) Foreign Application Priority Data
Mar. 7, 2013 (KR) 10-2013-0024602

(51) Int. Cl. C01B 33/107

(52) U.S. Cl. CPC C01B 33/10763

(57) ABSTRACT

The present invention relates to a method for preparing trichlorosilane. According to the method for preparing trichlorosilane of the present invention, trichlorosilane may be obtained with improved yield using silicon where copper silicide is formed.

### TECHNICAL FIELD

The present invention relates to a method for preparing trichlorosilane. More particularly, the present invention relates to a method for preparing trichlorosilane which may obtain trichlorosilane with improved yield using silicon where copper silicide is formed. This application claims the benefit of Korean Patent Application No. 10-2013-0024602 filed on Mar. 7, 2013 in the Korean Intellectual Property Office, the entire disclosure of which is herein incorporated by reference.

### BACKGROUND ART

Trichlorosilane (TCS) is one of most important raw material for preparing silicon for a semiconductor or a solar cell. As a method for preparing trichlorosilane, a direct chlorination reaction and a hydrochlorination (HC) reaction are commercially used. The hydrochlorination reaction is a reaction process of supplying silicon tetrachloride (STC) and hydrogen (H₂) to metallurgical silicon (MG-Si) and producing trichlorosilane under high temperature of 500 to 600° C. and high pressure of 20 to 30 bar.

Various methods have been suggested to increase the reaction rate of the hydrochlorination reaction. Japanese Patent Laid-Open Publication No. 1981-073617 and Patent Laid-Open Publication No. 1985-036318 disclose a method of adding a copper (Cu) catalyst, and Japanese Patent Laid-Open Publication No. 1988-100015 suggests adding a Cu mixture in the reaction.

However, although a copper catalyst contributes to increase in trichlorosilane yield in a fixed bed reactor, it contributes little in a fluidized bed reactor because copper particles may be aggregated due to the small particle size and may not easily contact with the surface of metallurgical silicon. In order to solve these problems, Japanese Patent No. 3708649, and Korean Patent Application No. 2007-7023115 have suggested various methods of supporting a copper catalyst on the surface of metallurgical silicon, but there is a problem in that the process becomes complicated.

### DISCLOSURE

### Technical Problem

In order to solve the problems of the prior art, it is an object of the present invention to provide a method for preparing trichlorosilane which is a simple and efficient process, may be industrially applied, and may obtain trichlorosliane with high yield.

### Technical Solution

In order to achieve the above object, the present invention provides a method for preparing trichlorosilane comprising heat treating silicon (Si) and a copper (Cu) compound to a temperature equal to or more than the melting point of the copper compound to form copper silicide (Cu-silicide) on the silicon; and supplying silicon tetrachloride and hydrogen to the silicon where Cu-silicide is formed to conduct a hydro chlorination reaction.

### Advantageous Effects

According to a method for preparing trichlorosilane of the present invention, trichlorosilane may be prepared with improved yield by a continuous and efficient process, by forming copper silicide on silicon, and then, conducting a hydrochlorination reaction using the silicon where copper silicide is formed.

### BRIEF DESCRIPTION OF DRAWINGS

FIG. 1 shows the results of observing MG-Si of Examples 1 to 5 and MG-Si without a copper compound by XRD (X-ray diffraction patterns).

FIG. 2 shows the results of observing the surfaces of MG-Si of Examples 1, 3, 4 and 5 using SEM (scanning electron microscope).

FIG. 3 shows the results of measuring Examples 1 and 5 using SEM-EDX (Energy-dispersive X-ray spectroscopy).

FIG. 4 is a graph measuring and showing the yields of trichlorosilane (SiHCl₃) according to the reaction time in Examples 1 to 3 and Comparative Examples 1 to 4.

### DETAILED DESCRIPTION OF THE INVENTION

As used herein, the terms a first, a second, and the like are used to explain various constitutional elements, and the terms are used only to distinguish one constitutional element from the other constitutional elements.

And, the terms used herein are used only to explain illustrative examples, and are not intended to limit the invention. A singular expression includes a plural expression unless otherwise means clearly. As used herein, the terms “comprise”, “include”, or “have” designate that described characteristics, numbers, steps, constitutional elements or combinations thereof are exist, but it should be understood that they do not previously exclude the possibility of existence or adding of one or more other characteristics, numbers, steps, constitutional elements or combinations thereof.

And, as used herein, in case a layer or an element is mentioned to be formed “on” layers or elements, it means that the layer or element is directly formed on the layers or elements, or it means that other layers or elements may be additionally formed between the layers, on a subject, on a substrate.

Although the present invention may have various forms and various modifications may be made thereto, specific examples will be exemplified and explained in detail. However, it is not intended to limit the present invention to disclosed forms, and it should be understood that all the modifications, equivalents or substitutions within the idea and technical scope of the present invention are included in the present invention.

Hereinafter, a method for preparing trichorosilane of the present invention will be explained in detail.

The method for preparing trichlorosilane of the present invention comprises heat treating silicon (Si) and a copper (Cu) compound to a temperature equal to or more than the melting point of the copper compound to form copper silicide (Cu-silicide) on the silicon; and supplying silicon tetrachloride and hydrogen to the silicon where Cu-silicide is formed to conduct a hydrochlorination reaction.

As a method for preparing trichorosilane, a direct chlorination reaction and a hydrochlorination (HC) reaction are commercially used.

The hydrochlorination reaction is a process of reacting silicon with silicon tetrachloride (STC) and hydrogen (H₂) to produce trichlorosilane at high temperature and high pressure, and the overall reaction is as shown in the following Formula 1.

3SiCl₄+2H₂+MG-Si→4SiHCl₃ [Formula 1]

The overall reaction of the Formula 1 may be divided into two steps of reactions as follows:

SiCl₄+H₂→SiHCl₃+HCl [Formula 2]

3HCl+Si→SiHCl₃+H₂ [Formula 3]

The reaction is an endothermic reaction with heat of reaction ΔH=37 kcal/mol, and commercially uses a fluidized bed reactor in order to increase a reaction area.

It is known that if a metal such as copper is used in the hydrochlorination reaction, reaction rate and selectivity may be increased. Thus, a method of introducing a copper compound such as CuCl or CuCl₂ in the reactor to produce trichlorosilane has been suggested, however, in this case, various problems may be caused in that flowability of the reaction may be lowered due to aggregation of copper particles and catalyst efficiency may be lowered.

Therefore, according to the present invention, instead of introducing a copper compound as a catalyst, silicon and a copper compound are mixed and heat treated to a temperature equal to or more than the melting point of the copper compound to form copper silicide (Cu-silicide) on the silicon, and then, a hydrochlorination reaction is conducted on the silicon where Cu-silicide is formed to prepare trichlorosilane. Namely, copper particles are not introduced as a catalyst, but Cu-silicide is formed on silicon and the silicon where Cu-silicide is formed is reacted, and thus, Cu-silicide functions for a catalyst of a hydrochlorination reaction and simultaneously, is involved in a hydrochlorination reaction to improve yield of the reaction without causing a problem of decrease in flowability due to aggregation of copper particles.

More specifically, first, a step of mixing silicon and a copper compound and heat treating to a temperature equal to or more than the melting point of the copper compound is conducted.

The silicon is not specifically limited as long as it is silicon of a grade that can be used for preparation of trichlorosilane, and for example, it may be metallurgical silicon (MG-Si) of fine particles having a particle diameter of about 10 to about 500 μm, preferably about 50 to about 300 μm. Silicon powder in the form of fine particles having the above particle diameter range may be obtained by pulverizing and classifying a metal silicon mass.

The silicon may have purity of about 98% or more, preferably about 99% or more, and it may include metal atoms such as Al, Ca, Ni, or Fe as impurities.

It is known that when copper or a copper-containing compound is added to hydrochlorination reaction system as a catalyst, reaction rate of trichlorosilane is improved to contribute to yield increase. However, a copper compound has a problem in that it may inhibit flowability because aggregation may easily occur in a reaction system. And, wide contact with a silicon surface should be secured so that the copper compound may act as a catalyst, however, when silicon is exposed in the air in a natural state, a natural oxide film that is chemically very stable is formed on the surface, which functions for disturbing contact of the copper compound with silicon. Thus, it fails to exhibit improvement effect of reaction rate satisfying commercially expected level.

To the contrary, according to the present invention, a copper compound itself is not used as a catalyst, but the copper atom of the added copper compound forms Cu-silicide on silicon, and the silicon where Cu-silicide is formed is used to conduct a hydrochlorination reaction. Thus, flowability may be secured because aggregation of copper compounds does not occur. And, more improved yield may be obtained, compared to the case wherein the same amount of a copper compound is introduced as a catalyst.

The step of forming Cu-silicide may be conducted by heat treating the silicon and the copper compound to a temperature equal to or more than the melting point of the copper compound.

The copper compound may be copper(I) chloride(CuCl), copper(II) chloride(CuCl₂) copper(I) oxide(Cu₂O), copper(II) oxide(CuO) in the form of cement, copper metal(Cu), or a mixture thereof, but is not limited thereto.

According to one embodiment of the invention, the copper compound may be used in an amount of about 0.01 to about 87 wt %, preferably about 0.1 to about 20 wt %, more preferably about 0.1 to about 10 wt % of the weight of silicon, based on the weight of copper (Cu) atom in the copper compound.

As the amount of the copper compound increases, yield of trichlorosilane usually increases, however, yield improvement effect may be sufficiently achieved with the above range.

The step of heat treating to prepare Cu-silicide may be conducted at a temperature equal to or more than the melting point of the copper compound, for example, about 300 to about 800° C., preferably about 300 to about 700° C., and at a pressure of about 1 to about 20 bar, preferably about 1 to about 5 bar.

And, the step of heat treating may be conducted under mixed gas atmosphere containing hydrogen.

According to one embodiment of the invention, the mixed gas may include about 10 wt % or less, for example, about 1 to about 10 wt % of hydrogen, and the remaining amount of inert gas such as argon (Ar) or nitrogen (N₂). As explained above, by heat treating under mixed gas atmosphere containing hydrogen, a natural oxide film that is produced on the surface of silicon is removed before the Cu-silicide is formed, and thus, the formation of Cu-silicide may be more facilitated. However, if too excessive amount of hydrogen is included, a silicon-hydrogen bond may be increased, and thus, it is preferable that hydrogen is included in the amount of 10% or less, and the remaining amount of inert gas is mixed.

By the above heat treatment process, Cu-silicide is formed on the silicon.

According to one embodiment of the invention, the Cu-silicide may be formed on a surface of the silicon.

According to one embodiment of the invention, as the Cu-silicide is formed, a plurality of fine holes with a diameter of about 0.1 to about 10 μm, preferably about 1 to about 5 μm may be generated on the surface of the silicon. By the holes on the surface of the silicon, the surface area of the silicon may be increased to further improve reactivity. In addition, metal atoms such as Al, Ca, Ni, or Fe existing in the silicon as impurities may be exposed outside and function as a catalyst, thus resulting in yield improvement.

Next, silicon tetrachloride (SiCl₄) and hydrogen are supplied to the silicon where Cu-silicide is formed to conduct a hydrochlorination reaction.

The step of forming the Cu-silicide and the step of conducting a hydrochlorination reaction may be continuously conducted. Namely, Cu-silicide is formed by the above-explained heat treatment in a reactor in which silicon and a copper compound are introduced, and into the same reactor, silicon tetrachloride and hydrogen may be continuously supplied to conduct a hydrochlorination reaction. At this time, since silicon where Cu-silicide is formed functions for improving reaction efficiency, the hydrochlorination reaction is conducted without introducing a separate catalyst.

According to one embodiment of the invention, the hydrogen and the silicon tetrachloride may be supplied in the mole ratio of about 5:1 to 1:5, preferably about 3:1 to 1:3.

The step of conducting the hydrochlorination reaction may be conducted at a temperature of about 300 to about 800° C., preferably about 500 to about 700° C., and a pressure of about 1 to about 50 bar, preferably about 5 to about 30 bar.

By the above hydrochlorination reaction, trichlorosilane may be prepared.

According to the preparation method of the present invention, about 10% or more yield improvement may be expected, compared to the case wherein a copper compound is introduced alone as a catalyst.

Hereinafter, the present invention will be explained in more detail with reference to the following Examples. However, these examples are only to illustrate the invention, and the right scope of the invention is not determined thereby.

### EXAMPLE

### Example 1

170 g of MG-Si having purity of 99% or more and an average particle size of 250 μm was mixed with CuCl₂ in the content of 1.4 wt % of MG-Si based on the weight of Cu in CuCl₂, and the temperature was elevated to 700° C. at 4° C./min under mixed gas atmosphere containing hydrogen and nitrogen in the weight ratio of 1:9. The mixture was maintained at 700° C. for 1 hour, and then, cooled to room temperature to obtain MG-Si where Cu-silicide is formed.

In a fixed bed reactor, 170 g of the MG-Si where Cu-silicide is formed was filled, and then, a hydrochlorination reaction was progressed at a temperature of 525° C., pressure of 20 barG, for 2 to 10 hours with a molar ratio of H₂:SiCl₄=2:1 to prepare trichlorosilane.

### Example 2

Trichlorosilane was prepared by the same method as Example 1, except that the CuCl₂ was mixed in the content of 2.7 wt % of MG-Si based on the weight of Cu in CuCl₂ in Example 1.

### Example 3

Trichlorosilane was prepared by the same method as Example 1, except that the CuCl₂ was mixed in the content of 4.1 wt % of MG-Si based on the weight of Cu in CuCl₂ in Example 1.

### Example 4

Trichlorosilane was prepared by the same method as Example 1, except that the CuCl₂ was mixed in the content of 5.3 wt % of MG-Si based on the weight of Cu in CuCl₂ in Example 1.

### Example 5

Trichlorosilane was prepared by the same method as Example 1, except that the CuCl₂ was mixed in the content of 6.6 wt % of MG-Si based on the weight of Cu in CuCl₂ in Example 1.

### Comparative Example 1

Trichlorosilane was prepared by the same method as Example 1, except that CuCl₂ was not mixed in Example 1.

### Comparative Example 2

In a fixed bed reactor, 170 g of MG-Si was mixed with CuCl₂ in the content of 1.4 wt % of MG-Si based on the weight of Cu in CuCl₂, and a hydrochlorination reaction was progressed at a temperature of 525° C., a pressure of 20 barG, for 2 to 10 hours with a molar ratio of H₂:SiCl₄=2:1 to prepare trichlorosilane.

### Comparative Example 3

Trichlorosilane was prepared by the same method as Comparative Example 2, except that the CuCl₂ was mixed in the content of 2.7 wt % of MG-Si based on the weight of Cu in CuCl₂ in Comparative Example 2.

### Comparative Example 4

Trichlorosilane was prepared by the same method as Comparative Example 2, except that the CuCl₂ was mixed in the content of 4.1 wt % of MG-Si based on the weight of Cu in CuCl₂ in Comparative Example 2.

### Experimental Example

### Analysis of X-Ray Diffraction Pattern of MG-Si

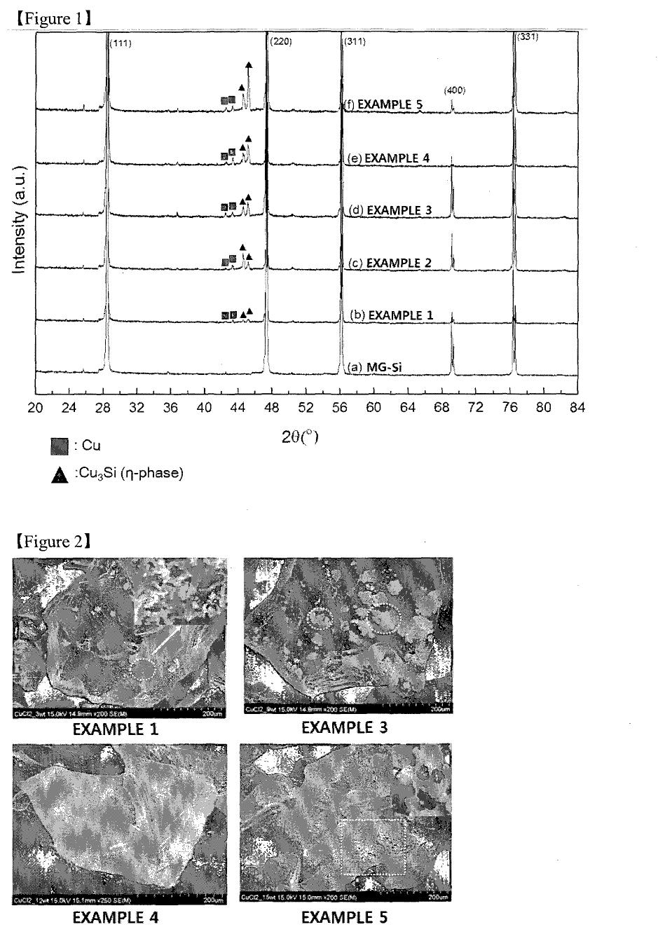

To analyze whether Cu-silicide was formed on the surface of MG-Si, the results of observing XRD (X-ray diffraction patterns) of the MG-Si of Examples 1 to 5 and the MG-Si without a copper compound are shown in FIG. 1.

Referring to FIG. 1, in Examples 1 to 5 wherein MG-Si was mixed with CuCl₂ and heat treated, Cu₃Si peaks are observed, and thus, it can be seen that Cu-silicide was formed.

Surface Observation of MG-Si

The results of observing the surfaces of MG-Si of Examples 1, 3, 4, and 5 using SEM with 200 times magnification are shown in FIG. 2.

Referring to FIG. 2, it can be seen that Cu-silicide was formed on the surface on MG-Si by mixing CuCl₂ with MG-Si and heat treating.

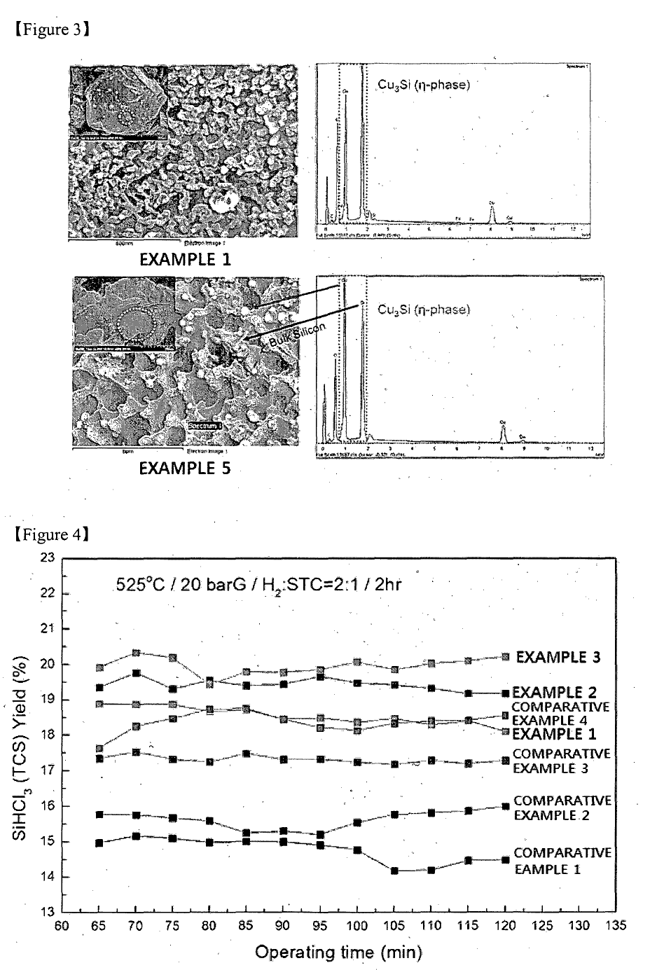

And, to analyze the components of Cu-silicide, the results of measuring Examples 1 to 5 with SEM-EDX are shown in FIG. 3.

Referring to FIGS. 2 and 3, it was observed that Cu-silicide phases are formed on MG-Si by mixing CuCl₂ with MG-Si and heat treating, and particularly, fine holes with a size of 1 to 2 μm are formed on the surface. By the fine holes, the specific surface area of MG-Si is rapidly increased, and metal impurities in the MG-Si may act as a catalyst.

Measurement of Trichlorosilane Yield

The yields of trichlorosilane (SiHCl₃) according to the reaction time were measured in Examples 1 to 3 and Comparative Examples 1 to 4, and shown in FIG. 4.

Referring to FIG. 4, it can be seen that if a hydrochlorination reaction was progressed using MG-Si where Cu-silicide is formed according the present invention, yield increased about 41% compared to Comparative Example 1 wherein a hydrochlorination reaction was progressed only with MG-Si.

And, comparing Examples 1 to 3 and Comparative Examples 2 to 4, respectively, yield increased about 11% compared to the case wherein a hydrochlorination reaction was progressed using the same concentration of CuCl₂.

1. A method for preparing trichlorosilane comprising
heat treating silicon (Si) and a copper (Cu) compound to a temperature equal to or more than the melting point of the copper compound to form copper silicide (Cu-silicide) on the silicon; and
supplying silicon tetrachloride and hydrogen to the silicon where Cu-silicide is formed to conduct a hydrochlorination reaction.

2. The method for preparing trichlorosilane according to claim 1, wherein the step of forming Cu-silicide is conducted under mixed gas atmosphere containing hydrogen.

3. The method for preparing trichlorosilane according to claim 2, wherein the mixed gas includes 10 wt % or less of hydrogen, and the remaining content of inert gas.

4. The method for preparing trichlorosilane according to claim 1, wherein the step of forming Cu-silicide and the step of conducting a hydrochlorination reaction are continuously conducted.

5. The method for preparing trichlorosilane according to claim 1, wherein the step of conducting a hydrochlorination reaction is conducted without introduction of a catalyst.

6. The method for preparing trichlorosilane according to claim 1, wherein the Cu-silicide is formed on a surface of the silicon.

7. The method for preparing trichlorosilane according to claim 1, wherein the copper compound includes at least one selected from the group consisting of CuCl, CuCl₂, Cu₂O, CuO, and Cu.

8. The method for preparing trichlorosilane according to claim 1, wherein the silicon is metallurgical silicon (MG-Si) having an average particle diameter of 10 to 500 μm.

9. The method for preparing trichlorosilane according to claim 1, wherein the heat treating is conducted at a temperature of 300 to 800° C.

10. The method for preparing trichlorosilane according to claim 1, wherein the step of conducting a hydrochlorination reaction is conducted at a temperature of 300 to 800° C. and a pressure of 1 to 50 bar.
